(19) United States
(12) Patent Application Publication
(10) Pub. No.: US 2015/0363567 A1
(43) Pub. Date: Dec. 17, 2015

(54) COMPREHENSIVE HEALTH ASSESSMENT SYSTEM AND METHOD

(71) Applicant: T.K. Pettus LLC, Minneapolis, MN (US)

(72) Inventor: Thomas K. Pettus, Minneapolis, MN (US)

(21) Appl. No.: 14/737,232

(22) Filed: Jun. 11, 2015

Related U.S. Application Data
(60) Provisional application No. 62/011,981, filed on Jun. 13, 2014.

(51) Int. Cl. G06F 19/00

(52) U.S. Cl. CPC G06F 19/3431; G06F 19/321

(57) ABSTRACT

Embodiments of the invention include a system and a method for providing a comprehensive overview of a patient's health record. In an embodiment, the invention includes normalizing data from previously administered assessments and calculating an overall health score. Other embodiments are also included herein.

This application claims the benefit of U.S. Provisional Application No. 62/011,981, filed Jun. 13, 2014, the contents of which are herein incorporated by reference.

### FIELD OF THE INVENTION

The present invention relates to a system of rating, calculating, or tracking a patient's overall health. More specifically, the present invention relates to a system that incorporates previously administered assessments to calculate a patient's overall health score.

### BACKGROUND OF THE INVENTION

The health care industry is treating a larger number of patients than ever before. The cost of care and treatment has also increased greatly. In many scenarios, a patient will start his or her treatment at a first facility, such as a hospital, and then be transferred to a second facility, such as a transitional care unit in a nursing home. As a patient transfers from a first facility to a second facility, much of the information learned at the first facility can be lost, such as through a lack of communication between the facilities or among healthcare providers.

In some scenarios, the second facility may conduct tests or assessments that have already been conducted by the first facility or a related test or assessment has already been conducted. The second facility may conduct one or more tests or assessments because they are unfamiliar with the test or assessment conducted by the first facility, such as the second facility being accustomed to using a different test, or the second facility did not receive the results of the test or assessment from the first facility.

Further, the current model of the healthcare industry does not have a standard that a healthcare professional can quickly review in order to determine the overall health condition of a patient. A first healthcare facility could be using a first system for measuring multiple elements of health status and a second healthcare facility could be using a second system. Also, in many cases the information management systems used by the two facilities are not compatible. If a patient is transferred from the first healthcare facility to the second healthcare facility, resources can be wasted by repeating steps taken at the first healthcare facility or information can be lost. A healthcare facility could be understaffed if the facility is treating numerous seriously sick or ill patients, such as patients that require additional attention, compared to the average. Alternatively, a healthcare facility could be overstaffed if the facility is treating numerous less seriously ill patients, such as patients that require less attention, compared to the average.

Finally, payment reform is creating more opportunities for health care providers to share savings with new collaborations. Risk-sharing partners need consistent specific outcomes or metrics on which to base contracting and program development, as well as to conduct negotiations and planning discussions.

Accordingly, there is a need for a comprehensive health assessment system that provides more useful information to healthcare providers, patients, and third party payers.

### SUMMARY OF THE INVENTION

In an embodiment, the invention provides a system for providing a comprehensive overview of a patient's health record, the system comprising a compilation module configured to compile data from one or more previously administered assessments; a processor comprising normalization module configured to normalize the data compiled from the one or more previously administered assessments; an aggregation module configured to calculate an overall health score to be representative of the patient's overall health, wherein the overall health score is calculated using a portion of the previously administered assessment data and excludes at least a portion of the previously administered assessment data from the calculation; and a display module configured to display the overall health score to a user through a user interface.

In an embodiment, the previously administered assessments include measures from one or more of the following: MDS, LTCC, Oasis, or other common data sets.

In an embodiment, the previously administered assessments include data on one or more of the following conditions prescription medication, psychotropic medications, cognitive level, ADLs, care support, dementia, delirium, fall risk, behavior, affect, comorbidities, skin condition, skin risk, nutrition, vision hearing pain, oral/dental status, IADLs, and reimbursement level.

In an embodiment, data from a second assessment is weighted more heavily in the calculation of the overall health score than data from a first assessment.

In an embodiment, the calculation of the overall health score includes weighting different data from the one or more previously administered assessments more heavily than alternative data from the one or more previously administered assessments.

In an embodiment, the previously administered assessments were administered at two or more different healthcare facilities,

In an embodiment, the system further comprises a reverse assessment module configured to calculate the score of a second assessment for a first characteristic, based on the results of a first assessment for the first symptom.

In an embodiment, the overall health score is a value of 0 to 10, wherein 0 is representative of little/no health risk and 10 is representative of high risk, or 10 is representative of little/no health risk and 0 is representative of high risk.

In an embodiment, when the same assessment has been previously administered two or more times, only the most recent assessment data is used in the calculation of the overall health score.

In an embodiment, when the same assessment has been previously administered two or more times, the more recent assessment data is weighed more heavily in the calculation of the overall health score.

In an embodiment, when the same characteristic has data for two or more assessments of the characteristic, the most recent assessment is weighted the heaviest.

In an embodiment, a patient's age is used in the calculation of the overall health score.

In an embodiment, the larger a patient's age the more heavily it is weighted in the calculation of the overall health score.

In an embodiment, at least one of the previously administered assessments includes data for more than one characteristic.

In an embodiment, the system further comprises a living situation module configured to assign a living situation number to a patient that represents the living situation of the patient.

In an embodiment, the living situation number is four digits.

In an embodiment, one digit of the living situation number represents the location of the patient, one digit of the living situation number represents the service of medical care, one digit of the living situation number represents the control the patient is under, and one digit of the living situation number represents information about hospice for the patient.

In an embodiment, the service of medical care includes none, informal services, or formal services.

In an embodiment, the control the patient is under includes none, monitored, or secured.

In an embodiment, the invention provides a method for providing an overall representation score of a patient's health status comprising compiling data from one or more previously administered assessments; normalizing the results from the one or more previously administered assessments; calculating an overall health score to be representative of the patient's overall health status, the overall health score is calculated using a portion of the previously administered assessment data and excludes at least a portion of the previously administered assessment data from the calculation; and displaying the overall health score to a user through a user interface.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a depiction of an environment in which the system could be used, according to an embodiment.

FIG. 2 is a depiction of different components of an environment and the system, according to an embodiment.

FIG. 3 is a flow chart of a portion of the system, according to an embodiment.

FIG. 4 is a schematic representing a portion of the system, according to an embodiment.

FIG. 5 is a screen shot of a portion of the user interface showing the overall assessment score, according to an embodiment.

FIG. 6 is a screen shot of a portion of the user interface showing the different assessments, according to an embodiment.

FIG. 7 is a screen shot of a portion of the user interface showing the different characteristics in the patient's record, according to an embodiment.

FIG. 8 is a screen shot of a portion of the user interface showing the different characteristics within an assessment, according to an embodiment.

FIG. 9 is a screen shot of a portion of the user interface showing a specific characteristic over time, according to an embodiment.

FIG. 10 is a depiction of an example computing environment wherein one or more of the embodiments set forth herein may be implemented.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

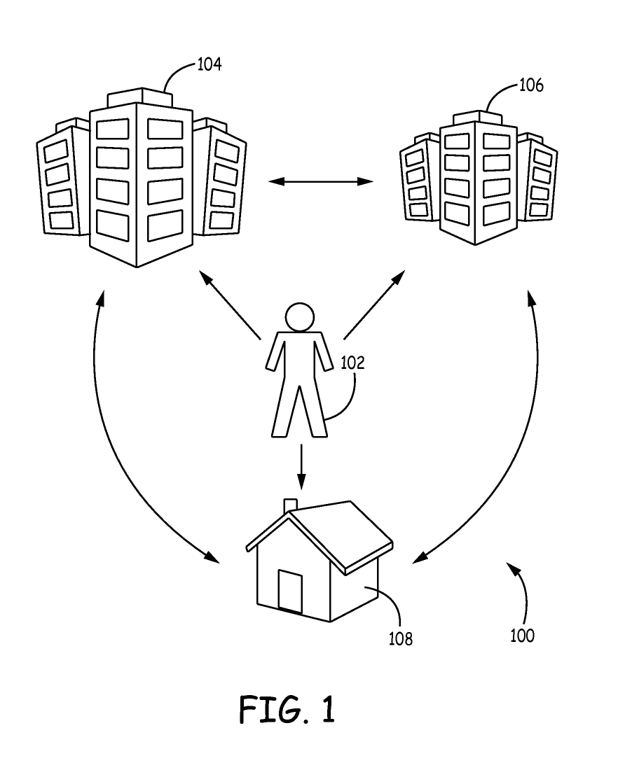

FIG. 1 is a depiction of a healthcare system 100 and portion of the environment. A patient 102 can have a medical issue, such as an ailment, a disease, a condition, a disorder, or an illness, that requires medical attention. The patient 102 can go to a first healthcare facility 104, such as a hospital, an emergency room, an urgent care, a doctor's office, or a transitional care facility, for medical attention. In some situations after the patient 102 has left the first healthcare facility 104, the patient 102 goes to a second healthcare facility 106, such as for additional medical attention, or rehabilitation. It should be understood that a patient 102 could be transitioned from the second healthcare facility to a third healthcare facility, to a fourth healthcare facility and so on. It should also be understood that patient 102 could be transitioned from the second healthcare facility back to the first healthcare facility 104, such as if the patient's condition worsens or returns. A patient 102 could also be transferred to his or her place of living 108 directly from the first healthcare facility 104.

In some scenarios a patient 102 can return to the place of living 108, such as a home, a nursing home, or an assisted living environment. It should be understood that a patient could have multiple places of living 108 at a time, such as if the patient has more than one home or apartment. It should be understood that a patient 102 could have different places of living 108 over time, such as if the patient's 102 health worsens or improves. If the patient's 102 health worsens, the patient 102 can require additional services compared to the previous place of living. If the patient's 102 health improves, the patient 102 can require fewer services at his or her place of living.

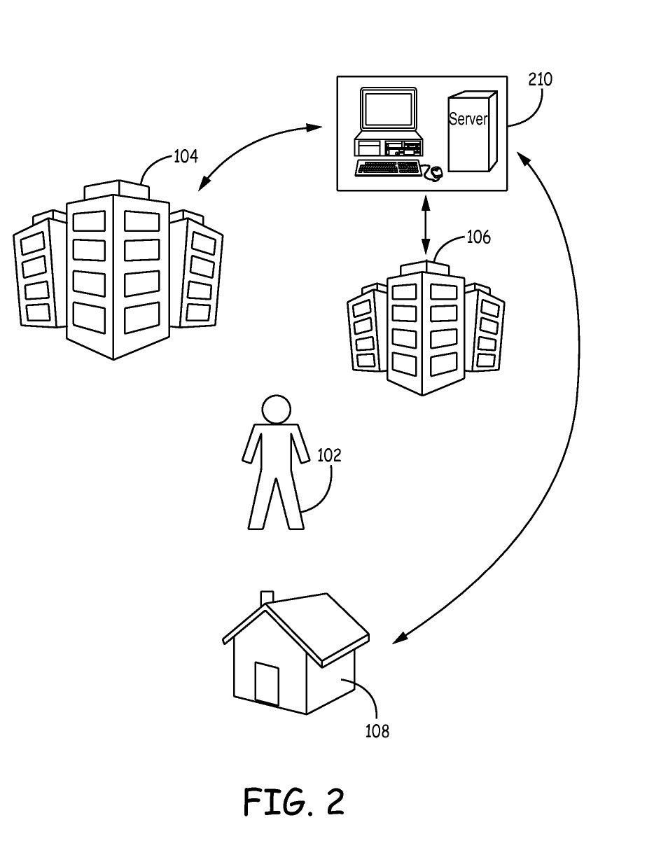

In reference to FIG. 2, a depiction of the healthcare system 100 is shown along with a comprehensive assessment system 210, according to an embodiment. The comprehensive assessment system 210, described herein, can improve communication between different healthcare facilities, improve care for the patient, and decrease costs for the patient and the providers.

In an example, the patient 102 can go to a first healthcare facility 104. The patient 102 can undergo a first assessment. A healthcare professional can enter the results of the first assessment into the system 210. The system can calculate an overall health score of the patient 102, such as a score that represents the patient's 102 overall health. The patient can be treated at the first healthcare facility 104.

After treatment at the first healthcare facility 104, the patient can be moved to a second healthcare facility 106, such as for additional treatment or care while the patient 102 recovers from their treatment or is treated further. At the second healthcare facility 106, a second assessment can be administered. The second assessment can be the same as the first assessment, include portions of the first assessment, include the first assessment and additional assessments, or be different from the first assessment.

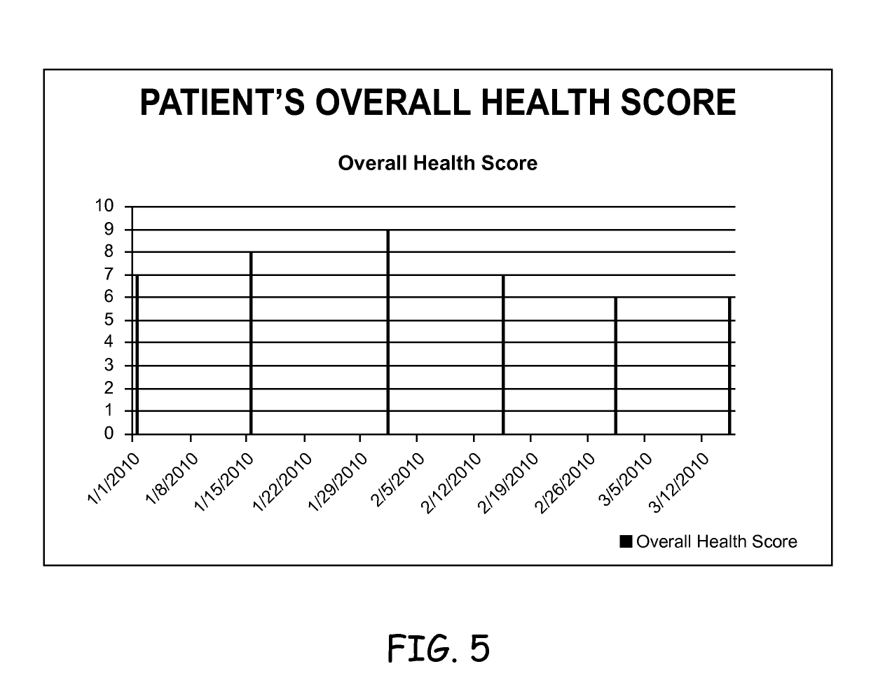

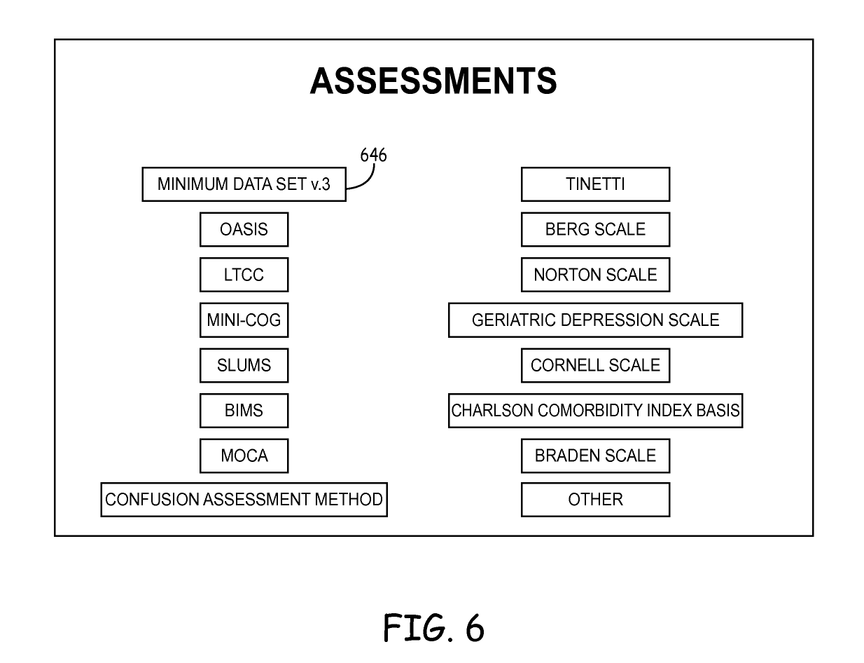

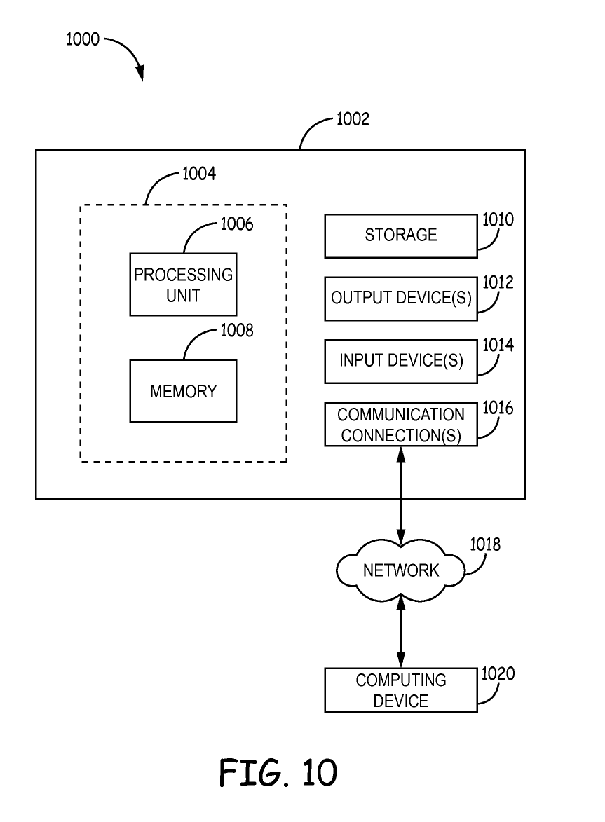

The results of the second assessment can be uploaded or otherwise entered into the system 210. The system 210 can recalculate the patient's overall health score using the results of the second assessment. In an embodiment, the recalculation of the patient's 120 overall health score can incorporate the first assessment and the second assessment, only the second assessment, or the second assessment and the parts of the first assessment that were not updated in the second assessment. The patient's 102 overall health score can be update each time he or she completes an assessment, such as throughout his or her life. In an embodiment, the first assessment and the second assessment are administered at the same healthcare facility. Future assessments can be administered at the same healthcare facility or different healthcare facilities, such as a first assessment at a first healthcare facility (such as a hospital) and a second assessment at a second healthcare facility (such as a transitional care unit). They system 210 can be connected to different healthcare facilities, such as through a network (as discussed below in reference to FIG. 10). The healthcare facilities can be located in the same city, different cities, different states, or different countries. The system 210 can track a patient's 102 overall health score (as shown in FIG. 5), such as to determine if a patient's 102 overall health is improving or diminishing. Similarly, the system 210 can track a patient's 102 results in regards to a specific characteristic (as shown in FIG. 6). The system 210 can track a patient's 102 results over time, such that a healthcare provided can determine if improvement has been made or not. The system 210 can retain a patient's 102 information and lock a patient's 102 file when the patient 102 is not currently in the care of a healthcare facility, or a patient's 102 information can be locked from healthcare facilities that are not currently caring for the patient 102.

In an embodiment, a healthcare professional can consider the overall health score of the patient 102 in determining the level of care necessary for the patient 102. In an embodiment, a healthcare professional can consider the overall health score of a patient in determining an estimated life expectancy of the patient 102. In an embodiment, a healthcare professional can consider the overall health score of a plurality of patients in order to determine staffing needs, such as if the patients at the healthcare facility have an average overall health score that is higher than the average overall health score for a plurality of patients, the healthcare facility might need additional staff. Conversely, if a group of patients have an average overall health score that is lower than average, the healthcare facility might be able to have fewer staff working. In an example, patients with lower overall health score (better health) will need less assistance and care, than patients with high overall health scores (worse health).

The first assessment can be administered by a healthcare professional, the patient 102, or automatically (such as an automated machine or device). In an embodiment, a healthcare professional can include a doctor, physician, a nurse, a medical technician, a care giver or other medical professionals. In an embodiment, the first assessment can include any testing or information gathering about the patient. The testing or information gathering about the patient 102 can include any information or data that indicates the patient's level of health or can be used to predict the future health of the patient 102. In an example, the first assessment can include a standardized test such as the Minimum Data Set (MDS), Long Term Care Consultation Document (LTCC or LTCSD), or Oasis.

A standardized test can include multiple tests, multiple assessments, or multiple measurement tools that gather or collect information on different characteristics of the patient 102, such as number of medications the patient 102 is taking, the number of psychotropic medications the patient 102 is taking, the cognitive levels, ADLs, care support, dementia, delirium, fall risk, behavior, affect, comorbidities, skin condition, skin risk, nutrition, vision, hearing, pain, oral/dental status, IADLs, reimbursement level. In an embodiment, a measurement tool can assess or measure a single characteristic. An assessment can include multiple measurement tools, such as the MDS, the LTCC or the Oasis. In an example, the first assessment can include an individual test or individual information gathering on an individual characteristic, such as height, weight, blood pressure, number of prescription medications, and other similar characteristics. The characteristics can include any information or data that is indicative or predictive of the patient's 102 current level of health or future level of health.

The results from the assessment(s) can be entered, uploaded or otherwise added into the comprehensive assessment system 210, such as through a user interface. The system 210 can aggregate and weight the different characteristics of the patient 102 into a single score that represents the patient's current status of health. In an embodiment, the score can include an aggregation of all of the assessments, only a selected group of the assessments, or only a portion of one or more of the assessment. In an embodiment, characteristics that are more predictive of a patient's overall health can be weighted more heavily than less predictive characteristics in the aggregation of the characteristics for the single score that represents the patient's current status of health.

In an embodiment, the number of medications the patient 102 is taking can be weighted as heavily as or more heavily than the number of psychotropic medications the patient 102 is taking. In an embodiment, the number of psychotropic medications the patient 102 is taking can be weighted as heavily as or more heavily than the cognitive levels of the patient 102. In an embodiment, the cognitive levels of the patient 102 can be weighted as heavily as or more heavily than the ADLs of the patient 102. In an embodiment, the ADLs of the patient 102 can be weighted as heavily as or more heavily than the care support the patient 102 has. In an embodiment, the care support the patient 102 requires can be weighted as heavily as or more heavily than the patient's 102 dementia results. In an embodiment, the patient's 102 dementia results can be weighted as heavily as or more heavily than the patient's 102 delirium results. In an embodiment, the patient's 102 delirium results can be weighted as heavily as or more heavily than the patient's 102 risk of falling. In an embodiment, the patient's 102 risk of falling can be weighted as heavily as or more heavily than the patient's 102 behavior. In an embodiment, the patient's 102 behavior can be weighted as heavily as or more heavily than the patient's 102 affect. In an embodiment, the patient's 102 affect can be weighted as heavily as or more heavily than the patient's 102 comorbidities. In an embodiment, the patient's 102 comorbidities can be weighted as heavily as or more heavily than the patient's 102 skin condition. In an embodiment, the patient's 102 skin condition can be weighted as heavily as or more heavily than patient's 102 skin risk. In an embodiment, the patient's 102 skin risk can be weighted as heavily as or more heavily than the patient's nutrition. In an embodiment, the patient's 102 nutrition can be weighted as heavily as or more heavily than the patient's 102 vision. In an embodiment, the patient's 102 vision can be weighted as heavily as or more heavily than the patient's 102 hearing ability. In an embodiment, the patient's 102 hearing ability can be weighted as heavily as or more heavily than the amount of pain the patient 102 has. In an embodiment, the amount of pain the patient 102 has can be weighted as heavily as or more heavily than the oral/dental status of the patient 102. In an embodiment, the oral/dental status of the patient 102 can be weighted as heavily as or more heavily than IADLs of the patient 102. In an embodiment, the IADLS of the patient 102 can be weighted as heavily as or more heavily than reimbursement level. Other relationships of weighting a characteristic against a different characteristic are possible.

In an embodiment, the characteristics can be weighted, such as to affect the overall health score more or less. In an embodiment, the number of medications and the number of psychotropic medications can be weighted with a nine (9). In an embodiment, the cognitive levels, the ADLs, and the care support can be weighted with an eight (8). In an embodiment, dementia, delirium, fall risk, and behavior can be weighted with a seven (7). In an embodiment, affect, and comorbidities can be weighted with a six (6). In an embodiment, skin condition, skin risk, and nutrition can be weighted with a five (5). In an embodiment, vision, hearing, and pain can be weighted with a three (3). In an embodiment, oral/dental status can be weighted with a two (2). In an embodiment, the IADLs can be weighted with a one (1). In an embodiment, the reimbursement level can be weighted with a ten (10).

In an embodiment, the system 210 can incorporate the number of medications the patient 102 is taking into the calculation of the patient's 102 overall health score. The number of medications can include only prescription medications, only over the counter medications, or both prescription medications and over the counter medications. In an embodiment, the system 210 can have a maximum number of medications that can be entered, such that if a patient is taking more medications than the maximum number of medications the system 210 can limit the number of medications to the maximum number of medications for calculation purposes. In an example, the maximum number of medications can be twenty (20), if a patient is taking 25 medications the system 210 can use the maximum number of medications, in this example 20, for the calculation of the patient's 120 overall health score. Other numbers for the maximum number of medications can be used, such as 10, 15, 25, 30, or 50. In an embodiment, the number of medications can include psychotropic medications the patient 102 is taking. In an embodiment, the number of medications does not include any psychotropic medications the patient 102 is taking.

In an embodiment, the system 210 can incorporate the number of psychotropic medications the patient 102 is taking into the calculation of the patient's 102 overall health score. In an embodiment, psychotropic medications can include any psychoactive drugs the patient is taking. The system 210 can limit the number of psychotropic medications to a maximum number of psychotropic medications, similar to the maximum number of medications. The maximum number of psychotropic medications can be set at 10. Other numbers for the maximum number of psychotropic medications can be used, such as 5, 6, 8, 12, or 15. In an embodiment, the maximum number of psychotropic medications is less than the maximum number of medications.

In an embodiment, the system 210 can incorporate the cognitive levels of the patient 102 into the calculation of the patient's 102 overall health score. In an embodiment, the system 210 can incorporate a score from a cognitive level assessment, such as the Cognitive Performance Test (CPT) or the Allen Cognitive Levels (ACL). Other cognitive level assessments can also be used.

In an embodiment, the system 210 can incorporate the patient's 102 activities of daily living (“ADLs”) into the calculation of the patient's 102 overall health score. In an embodiment, the system 210 can incorporate a score from an ADLs assessment, or from a portion of an assessment that observes a patient's ADLs, such as the Minimum Data Set (MDS), Long Term Care Consultation Document (LTCC or LTCSD), Outcome and Assessment Information Set (Oasis). In an embodiment, the MDS v.3 G0110 can be used. In an embodiment, the LTCC G.1-G.14 can be used. In an embodiment, the Oasis M1800-1890 can be used.

In an embodiment, the system 210 can incorporate the patient's 102 amount of care support into the calculation of the patient's 102 overall health score. In an embodiment, the system 210 can incorporate a score from a care support assessment, such as MDS v.3 10, LTCC Section E 2, 3, 5, 6, and 7, Oasis M2100 and M2110, or interdisciplinary team (IDT) assessment at a transitional care unit (TCU) discharge (DC)

In an embodiment, the system 210 can incorporate the patient's 102 dementia scores, signs, or symptoms into the calculation of the patient's 102 overall health score. In an embodiment, the system 210 can incorporate a score from a dementia assessment, such as Mini-Cog, St. Louis University Mental Status (SLUMS), Mini-Mental State Examination (MMSE), Brief Interview for Mental Status (BIMS) of MDS section C0500, Montreal Cognitive Assessment (MOCA), Short Blessed Test, LTCC Section H.10 (Katzman), and Oasis M1700 and M1710. In an embodiment, a 0 score on the Mini-Cog assessment can be indicative of a normal or negative result, and a 1 can be indicative of an abnormal or positive result. In an embodiment, the score for the Oasis assessment can be the function level (0-4) multiplied by the frequency (0-4).

In an embodiment, the system 210 can incorporate the patient's 102 delirium scores, signs or symptoms into the calculation of the patient's 102 overall health score. In an embodiment, the system 210 can incorporate a score from a delirium assessment, such as the Confusion Assessment Method (CAM), or the Intensive Care Delirium Screening Checklist (ICDSC).

In an embodiment, the system 210 can incorporate the patient's 102 fall risk into the calculation of the patient's 102 overall health score. In an embodiment, the system 210 can incorporate a score from a fall risk assessment, such as a Tinetti Score, MDS v.3 Section G0300, LTCC Sections G.6, G.7, and G.14, the Berg Scale, and Oasis M1032. In an embodiment, the MDS score can be equivalent to the sum of each activity (A-E) multiplied by steadiness (0-2). In an embodiment, the LTCC score can be equivalent to the transfer need (0-4) multiplied by the walking need (0-4). In an embodiment, the Oasis score can be equivalent to the number of checked boxes (0-6).

In an embodiment, the system 210 can incorporate the patient's 102 behavior into the calculation of the patient's 102 overall health score. In an embodiment, the system 210 can incorporate a score from a behavior assessment, such as found in the MDS v.3 Section E0200, LTCC Section G.13, and Oasis M1740 and M1745. In an embodiment, the MDS score can be equivalent to the sum of each behavior (A, B, C) multiplied by the frequency (0-3). In an embodiment, the Oasis score can be equivalent to the level (1-6) multiplied by the frequency (0-5)

In an embodiment, the system 210 can incorporate the patient's 102 affect into the calculation of the patient's 102 overall health score. In an embodiment, the system 210 can incorporate a score from an affect assessment, such as the Geriatric Depression Scale (short form or long form), the Cornell Scale, the MDS v.3 section D0600 (PHQ-9), LTCC Section H.5, or the Oasis M1730 (PHQ-2).

In an embodiment, the system 210 can incorporate the comorbidities of the patient 102 into the calculation of the patient's 102 overall health score. In an embodiment, the system 210 can incorporate a score from a comorbidities assessment, such as the Charlson Comorbidity Index Basis. In an embodiment, the system can incorporate a patient's age into the overall health score, such as in the calculation of the comorbidities, such as a number (representative of a patient's age) multiplied by the component in the Charlson Index. In an embodiment, the patient can be given a score of 0 if he or she is 40 years old or younger. The patient can be given a score of 1 if the patient is 41 years old to 50 years old. The patient can be given a score of 2 if the patient is 51 years old to 60 years old. The patient can be given a score of 3 if the patient is 61 years old to 70 years old. The patient can be given a score of 4 if the patient is 71 years old to 80 years old. The patient can be given a score of 5 if the patient is 81 years old or older. In an alternative embodiment, a patient younger than 50 years old can be given a score of 1, a patient 50-59 years old can be given a score of 1.25, a patient 60-69 years old can be given a score of 1.5, a patient 70-79 years old can be given a score of 1.75, a patient 80-89 years old can be given a score of 2.0, and a patient 90 years old or older can be given a score of 2.25.

In an embodiment, the system 210 can incorporate the patient's 102 skin condition into the calculation of the patient's 102 overall health score. In an embodiment, the system 210 can incorporate a score from a skin condition assessment, such as the MDS v.3 Section M0300 or the Oasis M1308. In an embodiment, the MDS score or the Oasis score can be equivalent to the sum of each stage, stage 1 (0-4), stage 2 (0-8), stage 3 (0-12), stage 4 (0-16), and unstageable (0-16).

In an embodiment, the system 210 can incorporate the patient's 102 skin risk into the calculation of the patient's 102 overall health score. In an embodiment, the system 210 can incorporate a score from a skin risk assessment, such as the Braden Scale, the Norton Scale, or the Oasis M1302.

In an embodiment, the system 210 can incorporate the patient's 102 nutrition into the calculation of the patient's 102 overall health score. In an embodiment, the system 210 can incorporate a score from a nutrition assessments, such as the MDS v.3 Section K0300, weight loss, or the Serum albumin. In an embodiment, the weight loss score can be equivalent to 1 if the patient has loss 5% or more of his or her body weight in one month or 10% or more of his or her body weight in 6 months. In an embodiment, the Serum albumin score can be equivalent to a 0 with a result of greater than 4.0, a 1 with a result of 2.0-4.0, or a 2 with a result less than 2.0.

In an embodiment, the system 210 can incorporate the patient's 102 vision into the calculation of the patient's 102 overall health score. In an embodiment, the system 210 can incorporate a score from a vision assessment, such as the MDS v.3 Section B1000, LTCC Section G.11, or the Oasis M1200.

In an embodiment, the system 210 can incorporate the patient's 102 hearing ability into the calculation of the patient's 102 overall health score. In an embodiment, the system 210 can incorporate a score from a hearing assessment, such as the MDS v.3 Section B0200, LTCC Section G.10, or the Oasis M1210.

In an embodiment, the system 210 can incorporate the amount of pain a patient 102 has into the calculation of the patient's 102 overall health score. In an embodiment, the system 210 can incorporate a score from a pain assessment, such as Linear Severity, Wong-Baker Faces, the MDS v.3 Section J0400 & J0600, and the Oasis M1242. In an embodiment, the MDS score can be equivalent to the frequency (J0400 inverted) multiplied by the intensity (J0600).

In an embodiment, the system 210 can incorporate the patient's 102 oral/dental status into the calculation of the patient's 102 overall health score. In an embodiment, the system 210 can incorporate a score from an oral/dental status assessment, such as the MDS v.3 Section L0200. In an embodiment, the MDS score can be equivalent to the number of checked boxes (A-F).

In an embodiment, the system 210 can incorporate the patient's 102 instrumental activities of daily living (“IADLs”) into the calculation of the patient's 102 overall health score. In an embodiment, the system 210 can incorporate a score from an IADLs assessment, such as the LTCC Section D.2-D.12, and the Oasis M2100 and M2110. In an embodiment, the LTCC score can be equivalent to the sum of box scores SD60-SD70.

In an embodiment, the system 210 can incorporate the patient's 102 reimbursement level into the calculation of the patient's 102 overall health score. In an embodiment, the system 210 can incorporate a score from a reimbursement level assessment, such as correlating to the insurance plan the patient 102 has or a RUGS IV score.

A characteristic score can be calculated or normalized for each characteristic. In an embodiment, the characteristic score can be from zero (0) to ten (10), such as zero correlating healthy/no risk, and ten correlating with unhealthy/extreme risk. Other ranges of scores are also possible, such as 10-0, 0-100, 100-0, 0-1000, or 1000-0. The scores can be normalized, such that scores across different characteristics are more easily compared, or scores of the same characteristic but different tests can be more easily compared.

For example, in regards to the patient's fall risk, Table 1 shows five different assessments and the ranges of scores for the assessments. As seen in Table 1, a Tinetti Score of 0 is not equivalent to 0 on the Berg Scale. Similarly, a score of 4 on the MDS is not equivalent to a score of 4 on the LTCC.

TABLE 1

| Assessment | Lowest Risk Score | Highest Risk Score |
|---|---|---|
| Tinetti Score | 28 | 0 |
| MDS v.3 Section G0300 | 0 | 8 |
| LTCC Sections G.6, G.7, G14 | 0 | 14 |
| Berg Scale | 56 | 0 |
| Oasis M1740 and M1745 | 0 | 30 |

The normalization of the scores can be linear. For example, if the normalization will be to a scale of 0 (low risk) to 10 (high risk), a Tinetti score of 28 can be normalized to 0, a Tinetti score of 14 can be normalized to 5, and a Tinetti score of 0 can be normalized to 10. In an additional example in regards to the Oasis assessment, a 0 can be normalized to 0, a 15 can be normalized to 5, and 30 can be normalized to 10.

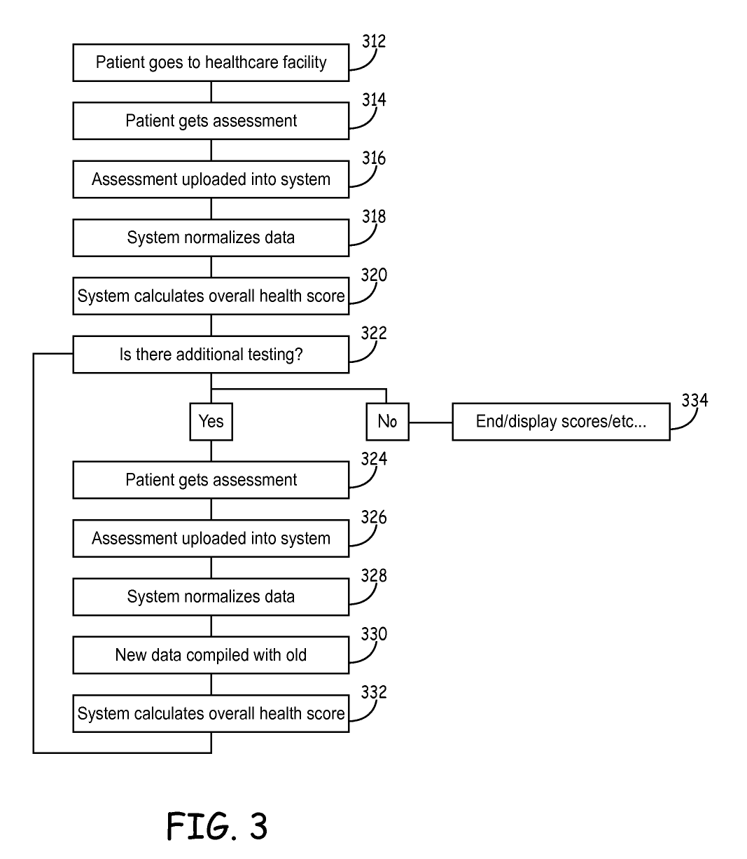

FIG. 3 shows a flow chart of the system 210, according to an embodiment. In an embodiment, a patient goes to a healthcare facility 312, such as to have an issue observed by a healthcare professional. At the healthcare facility, the patient can undergo one or more assessments 314, such as to observe, score, or otherwise determine the problems or issues that the patient is experiencing, may experience, or the likelihood hood of what the patient may experience. The assessment can provide a baseline or a current condition in regards to a problem or characteristic of the patient.

Once the assessment is finished, or during the assessment, the data or observations from the assessment can be uploaded or otherwise entered into the system 316. The system can normalize data from the assessment 318, such as to standardize the information displayed to a user, or to compare different tests for the same characteristic.

The system can aggregate the scores for different characteristic or from different assessments to calculate the overall health score 320. The system can ask a user if there are additional assessments 322. If there are additional assessments, the assessment can be administered to the patient 324, if necessary. In an embodiment, the additional assessments can be administered at a different time, such as after the patient has had some treatment or recovery, such as days, weeks, months, or years later. The data or results from the additional assessment can be uploaded 326 to the system. The system can normalize the data 328, similar to the prior normalization step. The system can compile the data from the assessments 330, such as to update old information with more current information. The system can recalculate the patient's overall health score 332. Once no additional assessments are going to be completed, such as for that day or if a user wants to see the most up to date information, the system can move to step 334 and display information to the user. The system can display information to the user, such as information related to the current and historical data of a characteristic or for an overall health score.

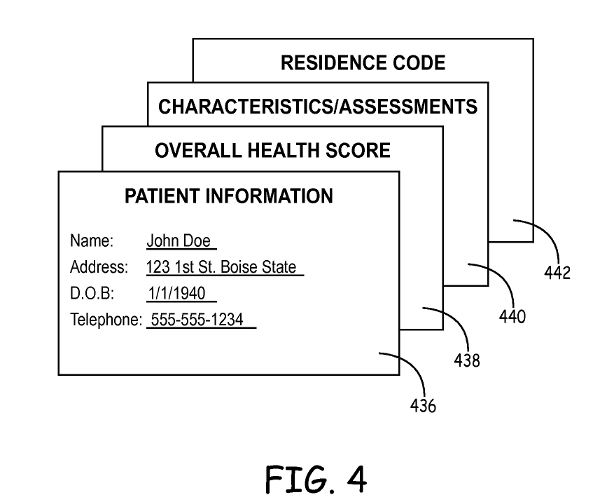

FIG. 4 is a schematic representing a portion of the system 210, according to an embodiment. The user interface of the system 210 can include a plurality of slides or screens that are shown to the user to depict different information. In an embodiment, the user interface of the system 210 shows the user a single slide or screen and the information shown on the slide or screen can change based on selections made by the user. FIG. 4 shows an embodiment of some of the slides that can be included in the user interface. In an embodiment, the user interface can include one or more demographics tables.

As shown in FIG. 4, a first slide 436 can include personal demographic tables or clinical demographic tables, such as a table that includes personal information about the patient, such as name, date of birth, social security number, address, height, weight, insurance information, or general health concerns. A second slide 438 can include the patient's overall health score and information relating to the patient's overall health score, such as shown in FIG. 5. The third slide 440 can include information about an assessment or a characteristic, such as shown in FIGS. 6-9. The fourth slide 442 can include information regarding a residence code for the patient, as discussed below.

In regards to the fourth slide 442, the system can include a living situation module configured to assign a living situation number to a patient. The living situation number can represent one or more aspect of the patients living situations, such as the location of the patient, the amount of medical care the patient is receiving, the amount of control the patient is under, and hospice information of the patient.

In an embodiment, the living situation number comprises 4 digits. The first digit can represent the location of the patients, such as a 1 represents a private home or apartment, a 2 represents a senior apartment, a 3 represents a group home, a 4 represents an assisted living residence, a 5 represents a nursing home, a 6 represents a transitional care facility, a 7 represents a hospital, and an 8 represents the patient has died.

In an embodiment, the second digit can represent the services the patient has, such as a 0 represents no services, a 1 represents informal services (such as friends and family), and a 2 represents formal services (such as licensed home care). In an embodiment, the third digit can represent the control the patient is under, such as a 0 represents none, a 1 represents monitored, and a 2 represents secured. In an embodiment, the fourth digit can represent the patient's hospice information, such as a 0 represents the patient is not in hospice, a 1 represents the patient has disenrolled from hospice, and a 2 represents the patient is currently in hospice.

FIG. 5 is a screen shot of a portion of the user interface showing the overall health score, according to an embodiment. The user interface can include a bar graph that shows the patient's current overall health score and the patient's previous overall health score. The bar graph can include a y-axis that shows the range of the overall health score. As discussed above, many different ranges are possible. In an embodiment, the range can be from 0 to 10. Zero can represent the best possible overall health score, lowest risk, and a ten can represent the most risk, such that the larger a bar on the bar graph the more at risk a patient is. The x-axis can include dates, such as when the overall health score was calculated, updated, or changed, such as because of an additional assessment or a reassessment of a characteristic.

The calculation of the overall health score can include weighting more recent assessments more heavily than past assessments. Further, if an assessment has been updated the system can ignore the previous or earlier assessment results in calculation of the new overall health score. Alternatively, the system can incorporate all of the previously administered assessment data, and weight more recent assessments more heavily than past assessments. In an embodiment, the overall assessment factors in whether or not a characteristic has been tested or assessed, such that if a characteristic has not been assessed, the system assumes the patient is not at risk in regards to that specific characteristic. In an embodiment of the calculation of the overall health score, the system can ignore assessment results that are not in regards to one of the specified characteristics, such that only a portion of an assessment can be used to determine the patient's overall health score.

In an embodiment, the system can calculate and display a confidence score, such as a score that reflects the confidence in the overall health score. The confidence score can be displayed to a user such as on through the user interface. The confidence score can be reflected as a percentage, such as 0% for little or no confidence and 100% for as much confidence as possible. Alternatively, the range can be reflected as a score of between 0-10, 0-100, or 0-1000. The confidence score can be calculated using a formula that includes the number of characteristic assessed and their respective weights. In an embodiment, the total weight points of entered characteristics can be divided by the total weight points possible.

In an embodiment, the weight scores for each possible characteristic can be added together to get the total weight points possible. For example, as described above the number of medication can have a weight score of 9, psychotropic medications can have a 9, cognitive levels can have an 8, ADLs can have an 8, care support can have an 8, dementia can have a 7, delirium can have a 7, fall risk can have a 7, behavior can have a 7, affect can have a 6, comorbidities can have a 6, skin condition can have a 5, skin risk can have a 5, nutrition can have a 5, vision can have a 3, hearing can have a 3, pain can have a 3, oral/dental status can have a 2, IADLs can have a 1, and reimbursement level can have a 10, therefore the total weight points possible can be 119. In an embodiment, the total weight points possible can be 109, such as if reimbursement level is not factored in.

If only five characteristics have been assessed and entered, the confidence score can reflect the total of the five characteristics' weight scores added together and then divided by 109 (the total weight points possible). For example, if the patient's delirium score has been entered as well as fall risk score, skin condition score, vision score, and hearing score, the weight points of these characteristics can be added together and divided by the total weight points possible to get a confidence score.

In an embodiment, a higher confidence score reflects the system having more confidence in the overall health score as a prediction of the patient's overall health. The confidence score can reflect how much information has been used to calculate the overall health score. The confidence score can reflect the relative weight of the information used in the overall health score. For example, a confidence score of 100% would be reflective of all of the possible information used to calculate an overall health score being used in the calculation of the current overall health score. In an example, the overall health score might only be using a few heavily weighted characteristics, which would have a higher confidence score than a different overall health score that used the same number of lower weighted characteristics. The confidence score can allow a user to quickly determine how much confidence to put in the overall health score based on the number of characteristics used in the calculation of the overall health score, and the weight of the characteristics used in the calculation overall health score.

FIG. 6 is a screen shot of a portion of the user interface showing some of the different assessments that can be administered to a patient, according to an embodiment. The user interface can include one or more buttons 646, that a user can select, such as to select an assessment. The user can select an assessment, such as to obtain more information about the assessments, such as the results of the assessment or to add additional results.

In an embodiment, the user can add a new assessment, such as an assessment that is not on the list or has not previously been administered. The user can enter a weighting value for the system to incorporate the new assessment into the overall health score accurately. The patient can enter normalization information, such that the system can correctly normalize the data from the new assessment, such as the most risky result and the least risky result.

In an embodiment, a user can relate two assessments, such as to obtain information the user is more familiar with. For example, a user might be more familiar with the MDS assessment. If only an OASIS assessment has been administered, the system can normalize the information from the OASIS assessment and then calculate the scores for the MDS assessment based on the MDS scores equivalents to the normalized scores. The user can then use or view the MDS scores, even if the MDS assessment has not been administered.

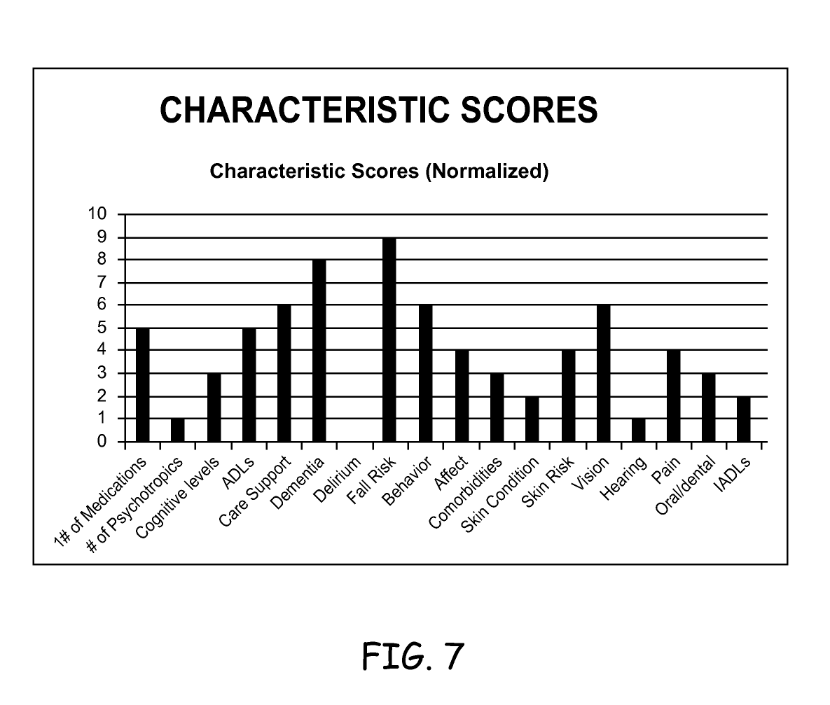

FIG. 7 is a screen shot of a portion of the user interface showing the different characteristics in the patient's record, according to an embodiment. In an embodiment, the system can include a user interface that displays the characteristics and their scores, such that a user can quickly identify which characteristics are the most at risk, or the affecting the overall health score the greatest amount. In an embodiment, the system can show a zero (0) for a characteristic that has not been assessed, such as delirium shown in FIG. 7. In an embodiment, the characteristics can be organized according to weighting, such as the farther left a characteristic is the more heavily weighted it is.

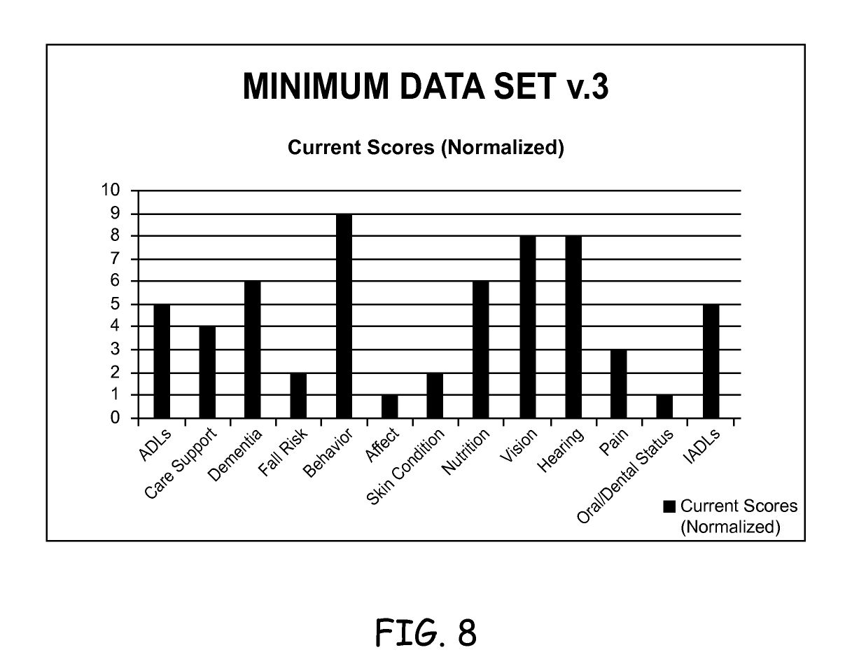

FIG. 8 is a screen shot of a portion of the user interface showing the different characteristics within an assessment, according to an embodiment. In an embodiment, the system can include a user interface that displays an assessment to a user, such as an assessment that assesses more than one characteristic. The assessment can be broken down into the scores for each characteristic and displayed to the user. In an embodiment, the bar graph can show previous scores for the characteristics as well as the current scores for the characteristics. FIG. 8 shows an example of a bar graph showing characteristics assessed in the MDS v.3.

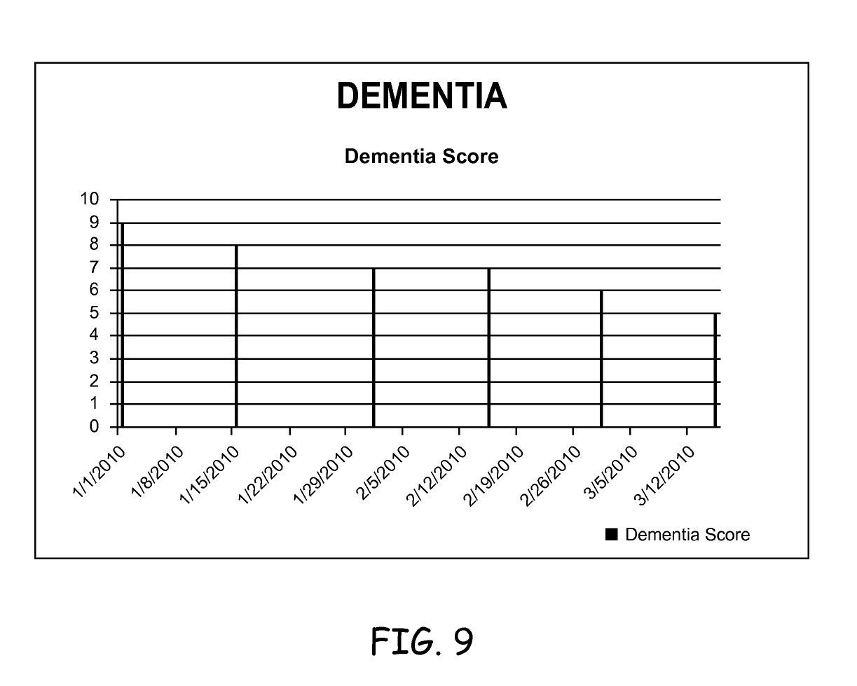

FIG. 9 is a screen shot of a portion of the user interface showing a specific characteristic over time, according to an embodiment. The user interface can display the previous assessment scores for a specific characteristic, such that a user can identify how the characteristic has changed over time. In the example shown in FIG. 9, the scores for dementia are shown. The scores shown can be the normalized scores from different assessments, such as Mini-Cog, Slums, and MOCA. The user can observe how the patient's score has changed, such as improved or got worse.

FIG. 10 shows an example of a computing device 1002 within the system 210, which can be used to carry out the embodiments described herein. Example computing devices include, but are not limited to, personal computers, server computers, hand-held or laptop devices, tablet computers, mobile devices, mobile phones, Personal Digital Assistants (PDAs), media players, multiprocessor systems, consumer electronics, mini computers, mainframe computers, and distributed computing environments that include any of the above systems or devices.

In one configuration, the computing device 1002 includes at least one processor 1006 and at least one memory component 1008. Depending on the exact configuration and type of computing device, the memory component 1008 may be volatile (such as RAM, for example), non-volatile (such as ROM, flash memory, etc., for example) or an intermediate or hybrid type of memory component. This combination of the processing unit 1006 and the memory unit 1008 is illustrated in FIG. 10 by dashed line 1004.

In some embodiments, device 1002 may include additional features, additional functionality or both. For example, device 1002 may include one or more additional storage components 1010, including, but not limited to, a hard disk drive, a solid-state storage device, and/or other removable or non-removable magnetic or optical media. In one embodiment, the storage component 1010 comprises non-transitory computer readable storage medium. In one embodiment, computer-readable and processor-executable instructions implementing one or more embodiments provided herein are stored in the storage component 1010. The storage component 1010 may also store other data objects, such as components of an operating system, executable binaries comprising one or more applications, programming libraries (e.g., application programming interfaces (APIs), media objects, and documentation. The computer-readable instructions may be loaded in the memory component 1008 for execution by the processor 1006.

The computing device 1002 may also include one or more communication components 1016 that allows the computing device 1002 to communicate with other devices. The one or more communication components 1016 may comprise (e.g.) a modem, a Network Interface Card (NIC), a radiofrequency transmitter/receiver, an infrared port, and a universal serial bus (USB) USB connection. Such communication components 1016 may comprise a wired connection (connecting to a network through a physical cord, cable, or wire) or a wireless connection (communicating wirelessly with a networking device, such as through visible light, infrared, or one or more radiofrequencies.

The computing device 1002 may include one or more input components 1014, such as keyboard, mouse, pen, voice input device, touch input device, infrared cameras, or video input devices, and/or one or more output components 1012, such as one or more displays, speakers, and printers. The input components 1014 and/or output components 1012 may be connected to the computing device 1002 via a wired connection, a wireless connection, or any combination thereof. In one embodiment, an input component 1014 or an output component 1012 from another computing device may be used as input components 1014 and/or output components 1012 for the computing device 1002.

The components of the computing device 1002 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of the computing device 1002 may be interconnected by a network. For example, the memory component 1008 may be comprised of multiple physical memory units located in different physical locations interconnected by a network.

Those skilled in the art will realize that storage devices utilized to store computer readable instructions may be distributed across a network. For example, a computing device 1020 accessible via a network 1018 may store computer readable instructions to implement one or more embodiments provided herein. The computing device 1002 may access the computing device 1020 and download a part or all of the computer readable instructions for execution. Alternatively, the computing device 1002 may download pieces of the computer readable instructions, as needed, or some instructions may be executed at the computing device 1002 and some at computing device 1020.

An exemplary computer-readable medium (e.g., a CD-R, DVD-R, or a platter of a hard disk drive) may be encoded with computer-readable data. This computer-readable data in turn comprises a set of computer instructions that, when executed by the processor 1006 of the computer device 1002, cause the computer device to operate according to the embodiments presented herein. In one such embodiment, the processor-executable instructions may be configured to cause the computer device to perform a method of evaluating a patient. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The processor can include a compilation module configured to compile data or results from one or more previously administered assessments. The compilation module can compile the results from administered tests, such as to organize the results based on when the assessment took place, such as chronologically. The compilation module can update stored information when a new assessment is completed and entered into the system.

The processor can include a normalization module configured to normalize the scores or results from an assessment, such that two scores from two different assessments for the same characteristic can be easily compared to each other. In an embodiment, the normalization module is configured to normalize scores to a range of zero (0) to ten (10).

The processor can include an aggregation module can compile or aggregate the scores of assessments, such as normalized scores, to calculate an overall health score for a patient. In an embodiment, the aggregation module uses a first portion of data from an assessment in calculating the overall health score for the patient, and does not incorporate a second portion of data from the assessment in the calculation of the overall health score.

The processor can include a display module configured to display information to a user. In an embodiment, the user can be a healthcare professional or a patient. In an embodiment, the display module can display assessment results, characteristic information, or overall health score information.

The processor can include a reverse assessment module configured to calculate the results of an assessment that was not conducted, based on the results of an assessment that was conducted. As discussed previously, a user can prefer to see the results of assessment A, however only assessment B was conducted. The reverse assessment module can calculate the predicted results of assessment A, based on the results of assessment B. In an embodiment, the reverse assessment module uses the normalized score of the performed assessment to calculate the predicted score of the assessment that was not performed.

The processor can include a living situation module. The living situation module can be configured to assign a living situation number to a patient that represents the living situation of the patient. In an embodiment, the living situation number can be multiple digits. In an embodiment, each digit can represent a different category of information, such as the type of residence the patient lives at, the amount of care the patient is given, the amount of control the patient is under, and information regarding the patient's hospice status.

The processor can include a confidence module. The confidence module can be configured to calculate a confidence score of an overall health score. In an embodiment, the confidence score is at least partially based on the predictiveness of the one or more characteristics used to calculate the overall health score. In an embodiment, the confidence score is at least partially based on the number of characteristics used in the calculation of the overall health score. In an embodiment, the confidence score is at least partially based on the weight given to the characteristics used in the calculation of the overall health score.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A system for providing a comprehensive overview of a patient's health record, the system comprising:
(a) a compilation module configured to compile data from one or more previously administered assessments;
(b) a processor comprising normalization module configured to normalize the data compiled from the one or more previously administered assessments;
(c) an aggregation module configured to calculate an overall health score to be representative of the patient's overall health, wherein the overall health score is calculated using a portion of the previously administered assessment data and excludes at least a portion of the previously administered assessment data from the calculation; and
(d) a display module configured to display the overall health score to a user through a user interface.

2. The system of claim 1, wherein the previously administered assessments include one or more of the following: MDS, LTCC, and Oasis.

3. The system of claim 1 wherein the previously administered assessments include data on one or more of the following conditions prescription medication, psychotropic medications, cognitive level, ADLs, care support, dementia, delirium, fall risk, behavior, affect, comorbidities, skin condition, skin risk, nutrition, vision, hearing, pain, oral/dental status, IADLs, and reimbursement level.

4. The system of claim 3, wherein data from a second assessment is weighted more heavily in the calculation of the overall health score than data from a first assessment, wherein the second assessment is administered after the first assessment.

5. The system of claim 1, wherein the calculation of the overall health score includes weighting different data from the one or more previously administered assessments more heavily than alternative data from the one or more previously administered assessments.

6. The system of claim 1, further comprising a reverse assessment module configured to calculate the score of a second assessment for a first characteristic, based on the results of a first assessment for the first symptom.

7. The system of claim 1, wherein the overall health score is a value of 0 to 10, wherein 0 is representative of little/no health risk and 10 is representative of high risk, or 10 is representative of little/no health risk and 0 is representative of high risk.

8. The system of claim 1, wherein when the same assessment has been previously administered two or more times, only the most recent assessment data is used in the calculation of the overall health score.

9. The system of claim 1, wherein when the same assessment has been previously administered two or more times, the more recent assessment data is weighed more heavily in the calculation of the overall health score.

10. The system of claim 1, wherein when the same characteristic has data for two or more assessments of the characteristic, the most recent assessment is weighted the heaviest.

11. The system of claim 1, wherein the larger a patient's age the more heavily it is weighted in the calculation of the overall health score.

12. The system of claim 1, wherein at least one of the previously administered assessments includes data for more than one characteristic.

13. The system of claim 1, further comprising a living situation module configured to assign a living situation number to a patient that represents the living situation of the patient.

14. The system of claim 13, wherein one digit of the living situation number represents the location of the patient, one digit of the living situation number represents the service of medical care, one digit of the living situation number represents the control the patient is under, and one digit of the living situation number represents information about hospice for the patient.

15. The system of claim 14, wherein the service of medical care includes none, informal services, or formal services.

16. The system of claim 14, wherein the control the patient is under includes none, monitored, or secured.

17. A method for providing an overall representation score of a patient's health status comprising:
compiling data from one or more previously administered assessments;
normalizing the results from the one or more previously administered assessments;
calculating an overall health score to be representative of the patient's overall health status, the overall health score is calculated using a portion of the previously administered assessment data and excludes at least a portion of the previously administered assessment data from the calculation; and
displaying the overall health score to a user through a user interface.

18. A system for providing a comprehensive overview of a patient's health record, the system comprising:
(a) a compilation module configured to compile data from one or more previously administered assessments;
(b) a processor comprising normalization module configured to normalize the data compiled from the one or more previously administered assessments;
(c) an aggregation module configured to calculate an overall health score to be representative of the patient's overall health, wherein the overall health score is calculated using one or more characteristics, the one or more characteristics assessed in one or more assessments and weight the one or more characteristics based on their predictive value of a patient's overall health; and
(d) a display module configured to display the overall health score to a user through a user interface.

19. The system of claim 18, wherein a characteristic that is more predictive is weighted more heavily than or equal to a characteristic that is less predictive.

20. The system of claim 18, comprising a confidence module configured to calculate a confidence score of an overall health score, wherein the confidence score is at least partially based on the predictiveness of the one or more characteristics used to calculate the overall health score.
